(19) United States
(12) Patent Application Publication
(10) Pub. No.: US 2015/0357129 A1
(43) Pub. Date: Dec. 10, 2015

(54) Electrically Conductive Structure

(71) Applicant: Szu-Wei Sun, Pingzhen City (TW)

(72) Inventor: Szu-Wei Sun, Pingzhen City (TW)

(21) Appl. No.: 14/477,908

(22) Filed: Sep. 5, 2014

(30) Foreign Application Priority Data
Jun. 10, 2014 (TW) 103210199

(51) Int. Cl. H01H 13/02

(52) U.S. Cl. CPC H01H 13/02

(57) ABSTRACT

An electrically conductive structure is provided with a hollow elastic member including an open bottom, a cavity, a pillar extending downward from a center of an inner surface into the cavity, a top platform, at least one hole open to the cavity, and a silver layer formed on a bottom of the pillar. Advantages such as elimination of short circuit and without heavy key depressing are obtained.

### BACKGROUND OF THE INVENTION

1. Field of the Invention

The invention relates to electrically conductive structures and more particularly to an electrically conductive structure for each key of keyboard or keypad to improve characteristics such as eliminating short circuit and to avoid pushing the key too strongly.

2. Description of Related Art

A conventional electrically conductive structure for each key of keyboard or keypad is shown in FIG. 7 and includes a hollow elastic member 11, a pillar 12 structure in center of the elastic member 11, and able to extend downward, a cavity 13 defined by the elastic member 11 and a circuit board (not numbered), a plurality of openings 14 located on a joining portion of the elastic member 11 and the circuit board, a carbon layer 15 formed on a bottom of the pillar 12, and a membrane switch 20 on the circuit board directly under the carbon layer 15.

In response to press down the elastic member 11, the pillar 12 moves downward to contact the membrane switch 20 for conduction and push air out of the cavity 13 via the openings 14.

However, the carbon layer 15 may be worn after many times of use. And in turn, it may increase electrical resistance, resulting in a poor contact. Thus, to push the key strongly when operating is required. Further, liquid may enter the cavity 13 to short circuit the membrane switch 20 via the openings 14.

Thus, the need for improvement still exists.

### SUMMARY OF THE INVENTION

It is therefore one object of the invention to provide a electrically conductive structure combining a hollow elastic member including an open bottom, a cavity, a pillar structure in center of the elastic member, and able to extend downward, a top platform, at least one hole open to the cavity, and a silver layer formed on a bottom of the pillar.

The above and other objects, features and advantages of the invention will become apparent from the following detailed description taken with the accompanying drawings.

### BRIEF DESCRIPTION OF THE DRAWINGS

FIG. 1A is a perspective view of an electrically conductive structure according to a first preferred embodiment of the invention;

FIG. 1B is a longitudinal sectional view of FIG. 1A;

FIG. 2A is a longitudinal sectional view of the electrically conductive structure of FIG. 1A mounted on one of keys of a keyboard or keypad;

FIG. 2B is a view similar to FIG. 2A showing a depressing of the electrically conductive structure;

FIG. 3A is a perspective view of an electrically conductive structure according to a second preferred embodiment of the invention;

FIG. 3B is a longitudinal sectional view of FIG. 3A;

FIG. 4A is a longitudinal sectional view of the electrically conductive structure of FIG. 3A mounted on one of keys of a keyboard or keypad;

FIG. 4B is a view similar to FIG. 4A showing a depressing of the electrically conductive structure;

FIG. 5A is a perspective view of an electrically conductive structure according to a third preferred embodiment of the invention;

FIG. 5B is a longitudinal sectional view of FIG. 5A;

FIG. 6A is a longitudinal sectional view of the electrically conductive structure of FIG. 5A mounted on one of keys of a keyboard or keypad;

FIG. 6B is a view similar to FIG. 6A showing a depressing of the electrically-conductive structure; and

FIG. 7 is a longitudinal sectional view of a conventional electrically conductive structure of one of keys of a keyboard or keypad.

### DETAILED DESCRIPTION OF THE INVENTION

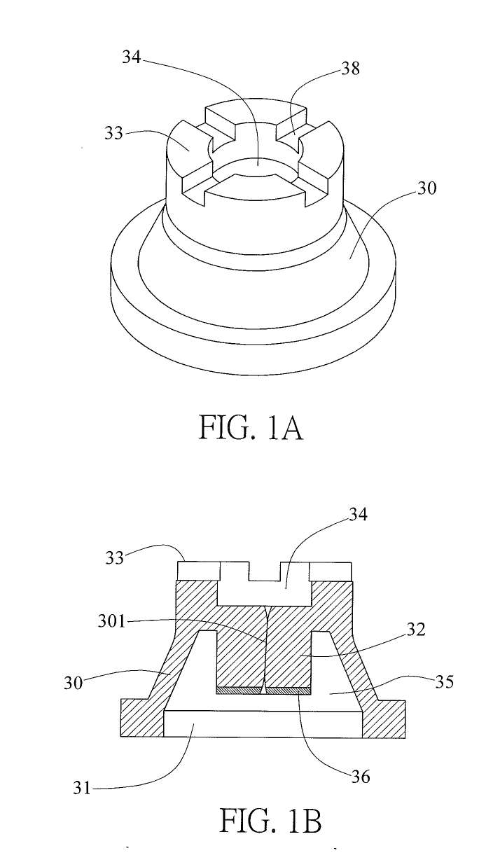

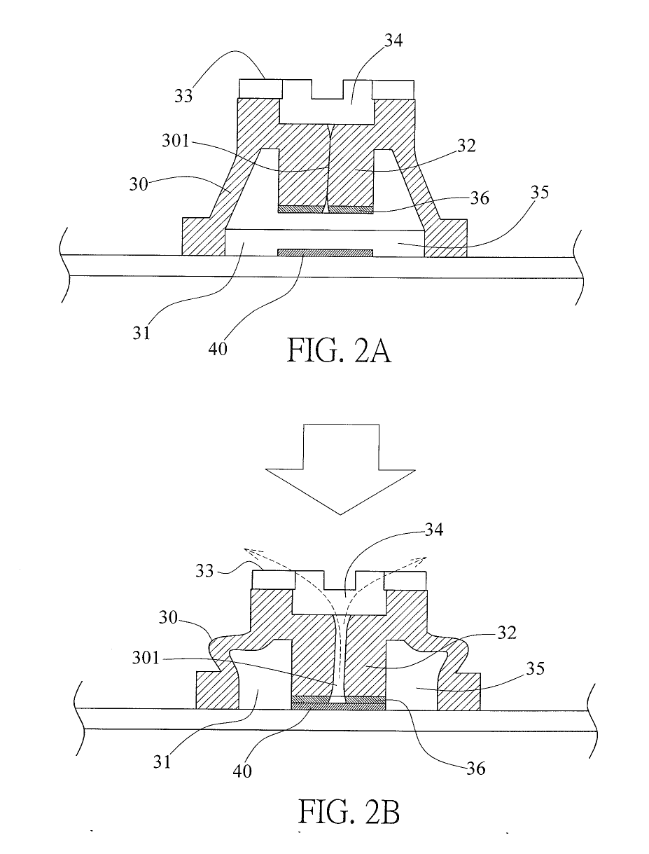

Referring to FIGS. 1A to 2B, an electrically conductive structure in accordance with a first preferred embodiment of the invention comprises the following components as discussed in detail below.

A hollow elastic member 30 is provided in one of a plurality of keys (not shown) of a keyboard or keypad. The elastic member 30 is formed of silicone rubber or plastic (i.e., being elastomeric). A pillar 32 structure in center of the elastic member 30, and able to extend downward. The elastic member 30 has an open bottom 31. A cavity 35 is defined by the elastic member 30 and a circuit board (not numbered). A fillister 34 is formed on a center of a top of the elastic member 30. Four platform 33 are formed on a circular edge of the top of the elastic member 30 and are engaged with a bottom of a keycap (not shown) of the key. Four channels 38 each are formed between two adjacent platform 33. An hole 301 is formed from bottom of the pillar 32 to the bottom of the fillister 34. The hole 301 is closed in a non-pressed state of the elastic member 30 (i.e., the key being not pressed). A silver layer 36 is formed on a bottom of the pillar 32. A membrane switch 40 is formed on the circuit board directly under the silver layer 36.

Alternatively, the silver layer 36 is replaced by an indium tin oxide (ITO).

As shown in FIG. 2B, in response to press down the elastic member 30, the elastic member 30 is deformed flexibly and the pillar 32 moves downward to contact the membrane switch 40 for conduction and push air out of the cavity 35 exiting via the open hole 301, the fillister 34, and the channels 38 as indicated by dashed arrows. To the contrary, the hole 301 is closed when the depressing force exerted on the elastic member 30 is released.

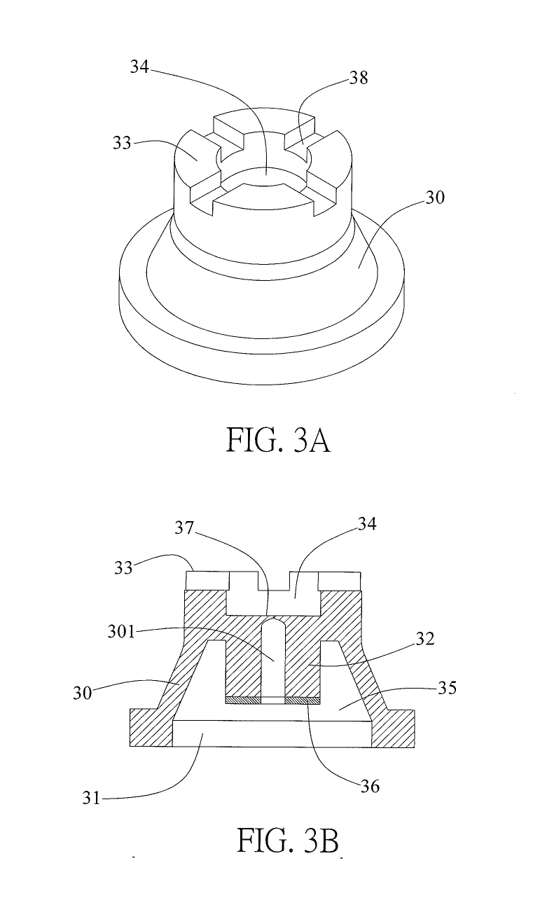

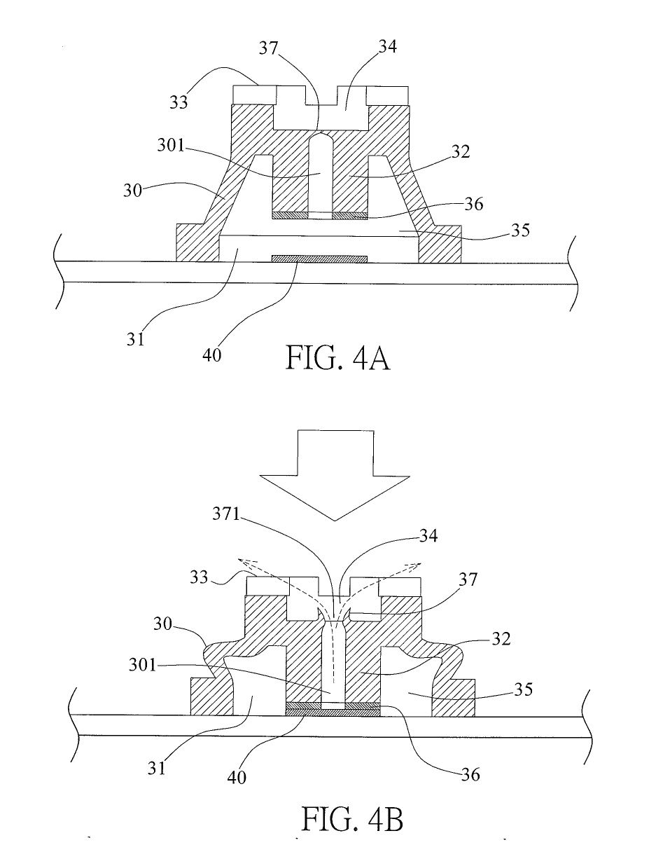

Referring to FIGS. 3A to 4B, an electrically conductive structure in accordance with a second preferred embodiment of the invention is shown. The characteristics of the second preferred embodiment are substantially the same as that of the first preferred embodiment except the following:

A larger hole 301 is formed from bottom of the pillar 32 to a position proximate to the bottom of the fillister 34. A flap 37 is formed of silicone rubber or plastic (i.e., being elastomeric) and is adapted to interconnect the bottom of the fillister 34 and a top-end of the elastic member 301. A central opening 371 is formed through the flap 37 but it is closed when the elastic member 30 is not depressed.

Wherein the flap 37 is disposed on a top, bottom or middle of the hole 301, the opening 371 is disposed in a center or edge of the flap 37, and the flap 37 is formed of silicone rubber or plastic.

As shown in FIG. 4B, in response to press down the elastic member 30, the elastic member 30 is deformed flexibly, the central opening 371 is open, and the pillar 32 moves downward to contact the membrane switch 40 for conduction and push air out of the cavity 35 exiting via the hole 301, the central opening 371, the fillister 34, and the channels 38 as indicated by dashed arrows. To the contrary, both the central opening 371 and the flap 37 are closed when the depressing force exerted on the elastic member 30 is released.

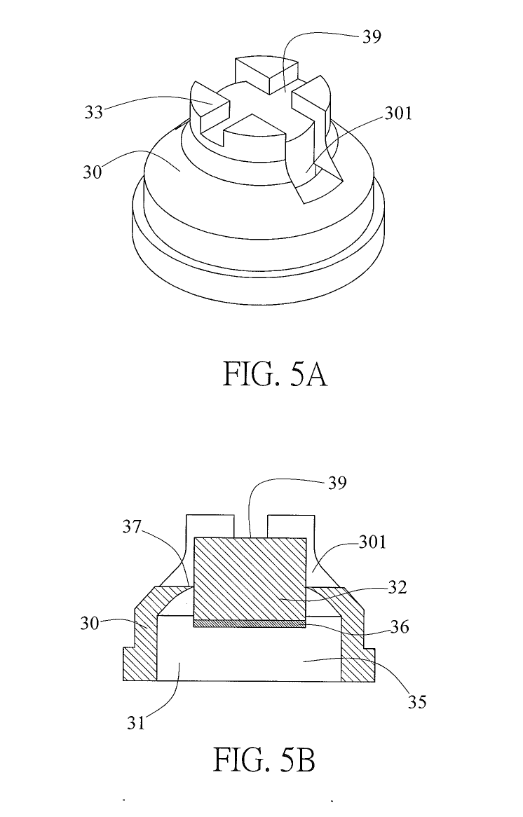

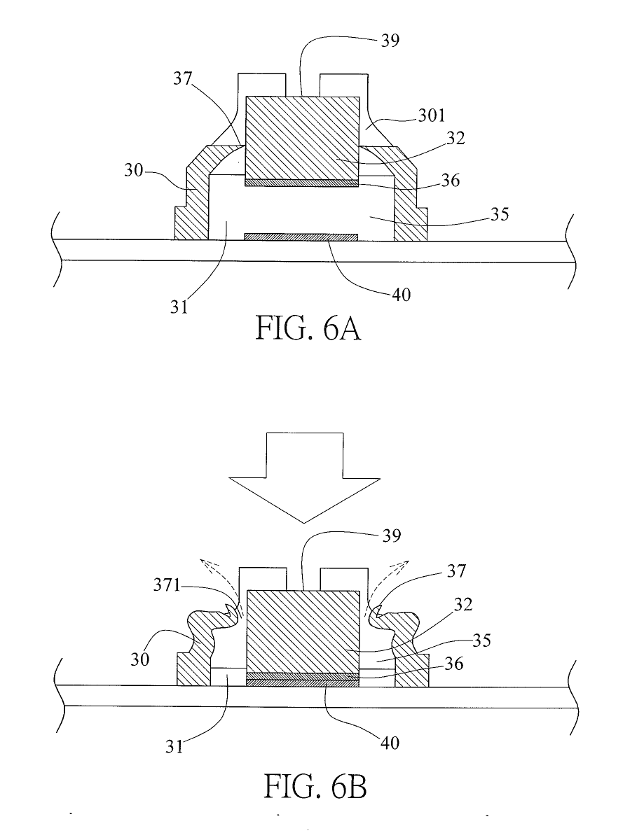

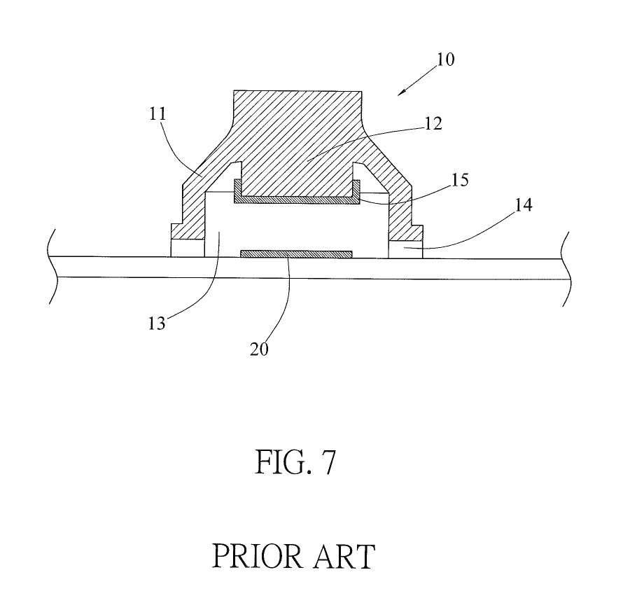

Referring to FIGS. 5A to 6B, an electrically conductive structure in accordance with a third preferred embodiment of the invention is shown. The characteristics of the third preferred embodiment are substantially the same as that of the first preferred embodiment except the following:

A platform 33 having a flat top is formed on the elastic member 30. Two opposite holes 301 are formed on a periphery of the platform 33. No opening is formed through the pillar 32.

As shown in FIG. 6B; in response to press down the elastic member 30, the elastic member 30 is deformed flexibly and an opening 371 is formed between the pillar 32 and the flexibly deformed flap 37. Thus, air in the cavity 35 exits via the openings 371 and the holes 301 as indicated by dashed arrows. To the contrary, the openings 371 are closed when the depressing force exerted on the elastic member 30 is released.

There are two grooves 39 shaped as a cross formed on the platform 33 for preventing the platform 33 from contacting bottom of the keycap.

It is envisaged by the invention that the following advantages are obtained: The silver or ITO layer formed on the bottom of the pillar 32 can increase times of contact between itself and the membrane switch without being worn. Thus, electrical resistance is not increased and good electrical contact is substantially maintained and these are great improvements over the prior art. The cavity inside the elastic member 30 is closed when the elastic member 30 is not been pushed, and the opening 371 is open only when the elastic member 30 is pushed. Thus, no liquid may enter the elastic member 30. This can prevent short circuit and to avoid pushing the key too strongly is required.

While the invention has been described in terms of preferred embodiments, those skilled in the art will recognize that the invention can be practiced with modifications within the spirit and scope of the appended claims.

What is claimed is:

1. An electrically conductive structure comprising:
a hollow elastic member including an open bottom, a cavity, a pillar structure in center of the elastic member, and able to extend downward, at least a top platform, at least one hole open to the cavity, and a silver layer formed on a bottom of the pillar.

2. The electrically conductive structure of claim 1, wherein the pillar is formed of silicone rubber or plastic.

3. The electrically conductive structure of claim 1, wherein the pillar includes a hole through a bottom to communicate with the cavity.

4. The electrically conductive structure of claim 1, wherein the pillar includes two opposite holes communicating with the cavity.

5. The electrically conductive structure of claim 1, wherein the silver layer is replaced with an indium tin oxide (ITO).

6. The electrically conductive structure of claim 3, wherein the platform includes a central fillister communicating with the hole, and at least one channel communicating between an edge of the platform and the central fillister.

7. The electrically conductive structure of claim 3, wherein the hole includes a flap having a normally closed opening.

8. The electrically conductive structure of claim 4, wherein the hole includes a flap having a normally closed opening.

9. The electrically conductive structure of claim 7, wherein the flap is disposed on a top, bottom or middle of the hole, the opening is disposed in a center or edge of the flap, and the flap is formed of silicone rubber or plastic.

10. The electrically conductive structure of claim 8, wherein the opening is disposed in a center or edge of the flap, and the flap is formed of silicone rubber or plastic.

11. The electrically conductive structure of claim 3, further comprising at least one groove.
